(19) United States
(12) Patent Application Publication
(10) Pub. No.: US 2025/0384501 A1
(43) Pub. Date: Dec. 18, 2025

(54) MANAGING USER PARTICIPATION IN INPUT OF AN INTELLECTUAL PROPERTY DESCRIPTION

(71) Applicants: Charles John Kulas, San Franicisco, CA (US); Carter Bart Sullivan, Benicia, CA (US)

(72) Inventors: Charles John Kulas, San Franicisco, CA (US); Carter Bart Sullivan, Benicia, CA (US)

(21) Appl. No.: 19/241,078

(22) Filed: Jun. 17, 2025

Related U.S. Application Data
(60) Provisional application No. 63/661,287, filed on Jun. 18, 2024.

(51) Int. Cl. G06Q 50/18; G06F 21/62

(52) U.S. Cl. CPC G06Q 50/184; G06F 21/6254

(57) ABSTRACT

A degree of input from a human user to create, originate, or otherwise define intellectual property (IP) as an input to a digital system can be measured and compared with non-user-created IP input such as machine-created input, or input created by a different human. If the degree of participation does not meet a threshold or value then the human user can be prompted to input more information. The comparison of user to non-user inputs can be weighted by importance to specific issues such as the creation of a work, or the conception of an invention. A participation value can be displayed and updated as the user enters information to a digital input system—such as by typing, gesturing, talking, drawing or using other input means.

### CROSS REFERENCES TO RELATED APPLICATIONS

This application claims the benefit of U.S. Provisional Patent Application Ser. No. 63/661,287, entitled METHOD AND SYSTEM FOR AUTOMATED GENERATION OF INVENTION DISCLOSURES USING ARTIFICIAL INTELLIGENCE, filed on Jun. 18, 2024, which is hereby incorporated by reference as if set forth in full in this application for all purposes.

### BACKGROUND

The process of drafting Intellectual Property (IP) documents such as invention disclosures, patent applications, papers, thesis material, technical presentations, and the like are traditionally labor-intensive tasks that require a deep understanding of the technology, patent language, legal requirements, and technical knowledge related to the IP. For instance, preparing a patent application often involves writing detailed descriptions and claims, generating technical drawings, and categorizing the invention within the correct technological field—all of which must be done in a manner that meets the standards of target audiences such as the public, elementary schools, teachers, universities, patent examiners, scientists, engineers, and the like.

With regard to patents, the accuracy and quality of a patent application are critical for the protection of intellectual property, yet the complexity of this task poses a barrier, especially for independent inventors and smaller entities. Advancements in artificial intelligence (AI) have started to shift the traditional approach, providing opportunities to streamline and enhance the patent application process by automating certain aspects of document creation, data analysis, and content generation.

The process of drafting IP works such as patent applications is traditionally a labor-intensive task that requires a deep understanding of the technical language, legal requirements, and technical knowledge related to the invention. For instance, preparing a patent application often involves writing detailed descriptions and claims, generating technical drawings, and categorizing the invention within the correct technological field-all of which must be done in a manner that meets the standards of patent offices. The accuracy and quality of a patent application are critical for the protection of intellectual property, yet the complexity of this task poses a barrier, especially for independent inventors and smaller entities.

Advancements in artificial intelligence (AI) have started to shift the traditional approach, providing opportunities to streamline and enhance the IP generation process such as patent application development by automating certain aspects of document creation, data analysis, and content generation.

The problem addressed by this invention described is the traditionally labor-intensive and complex process of generating IP for disclosures such as invention disclosures and patent applications, which requires significant technical and legal expertise.

Inventors and companies often struggle with capturing the intricate details of their innovations in a manner that is both comprehensive and compliant with technical writing requirements, patent laws, etc., which can impede the protection of intellectual property.

This issue is further compounded by the need to create detailed technical drawings and provide accurate descriptions that align with the IP's functionality and output. The challenge lies in streamlining this process, making it more accessible and less resource-intensive, while maintaining the high standards required for successful IP disclosure generation for uses in developing and producing technical writings such as patent applications.

One concern when using AI systems to create intellectual property is the amount or degree of a human's participation in the creation of the IP. If human participation is not sufficient, creation may be attributed to a non-human machine or process that can preclude or impede ownership of the IP.

### SUMMARY

A novel AI-driven methodology and system that automates the creation of comprehensive IP disclosure such as needed for technical papers, patent applications, and the like is described herein.

Utilizing a flexible AI model, Intellectual Property Disclosure System (IPDS) generates an IP disclosure by receiving an initial description of the technology, which could range from a brief few sentences to extensive explanations.

The AI uses specialized prompts tailored to the complexity and content of the input provided by the user, guiding the model to produce relevant and enabling content that aligns with the intended operation or output of an IP disclosure used to disclose, for example, an invention, technical paper, technical process, textbook, and the like. These prompts may adjust dynamically, ensuring the AI focuses on the most pertinent information, whether it is concerning the output characteristics of the innovation or its underlying process.

The IPDS may generate corresponding technical drawings, encompassing flow diagrams for use in IP such as technical papers, technical presentations, process-driven inventions and mechanical drawings for physical devices, and the like, complete with reference numbers and figure descriptions.

A degree of human user-created IP description input can be measured and compared with non-user-created IP input such as machine-created input, or input created by a different human. If the degree of participation does not meet a threshold or value then the human user can be prompted to input more information. The comparison of user to non-user input can be weighted by importance to specific issues such as creation of a work or conception of an invention. A participation value can be displayed and updated as the user enters information—such as by typing, talking or drawing—as they use the input system.

The IPDS may provide for a process to mask confidential data that may be inputted into an open AI system. The masking process provides sufficient information to leverage the power of the AI architecture to put together enabling disclosure, while protecting confidential information such as inventions not yet filed as patent applications, trade secrets, personal information, and the like.

The output(s) of the AI system(s) using the masked data may then be input into an unmasking process used to generate the enabling language and figures along with the confidential data.

The IPDS may also provide a verbosity module used to increase or decrease the verbosity relative to a target audience such as patent examiners.

A further understanding of the nature and the advantages of particular embodiments disclosed herein may be realized by reference to the remaining portions of the specification and the attached drawings.

### BRIEF DESCRIPTION OF THE DRAWINGS

FIG. 1 illustrates an automated method and system for generating IP disclosures and/or patent applications, technical writings, and the like using an artificial intelligence.

FIG. 2 illustrates an automated method and system for generating IP disclosures and/or patent applications, technical writings, and the like using an artificial intelligence.

FIG. 3 illustrates an automated method and system employed for generating IP disclosures and/or patent applications, technical writings, and the like using an automated system such as artificial intelligence.

FIGS. 4-10 include screenshots of an example user interface for an “invention disclosure form,” or “intake” form that has been automated.

FIGS. 11-13 illustrate steps in a user inputting information into an input box, and also automatically generating text for an input box.

### DETAILED DESCRIPTION

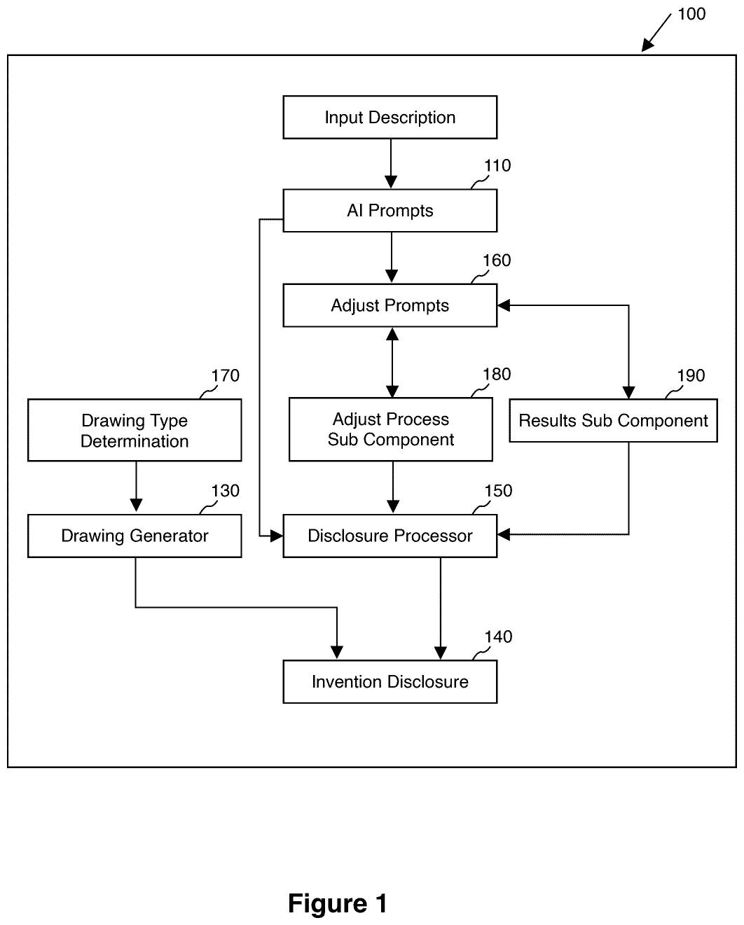

### I.1. System Description—FIG. 1

In one implementation, Intellectual Property Disclosure System (IPDS) 100 is a system configured to generate IP disclosures which may be used to prepare technical writings such as patent applications, technical papers, etc., using one or more automated systems such as artificial intelligence (AI) systems. Although the Figures illustrate specific modules and interconnections, they are used to show examples of basic characteristics of embodiments that can vary in other implementations. Components of the example illustrations may be modified, omitted, or added while still providing a suitable system for implementing any one or more of the features described, herein.

Here, IPDS 100 is depicted as a flowchart with nodes and relationships indicating the steps and components involved in this inventive process. The following is a detailed explanation of each component and its function within the overall system:

Input Description 102 provides a starting point of the process where the user provides a description of the intellectual property (IP) to IPDS 100. This description can vary significantly in length and complexity, from succinct sentences to elaborate details of the invention, thesis, paper, project, etc.

Upon receiving the description, IPDS 100 employs AI Prompts 110 to generate specialized prompts that guide an AI model, such as an AI Large Language Model (LLM) in processing the input data. These prompts are designed to help derive a comprehensive understanding of the IP based on the information provided by the user.

Adjust prompts module 160 provides for dynamically adjusting the prompts to tailor the AI's focus depending on the type and content of the description provided and enabling disclosure required. For example, if the content was a few words covering the heating of a wire filament, the prompts to the AI system may be adjusted to expand on how wire filaments are heated to a level understandable by one skilled in the art of heating wire filaments to heat filaments. In some respects, the adjust prompts process may compare the output of the AI system to prior art used by engineers and others to determine the level of adjustment necessary.

In some configurations, two subcomponents may work in conjunction with adjust prompts 160:

Based on the operation or process emphasis, adjust process sub-component 180 adjusts the AI prompts to ensure the resulting disclosure highlights the IP processes and functioning.

When the user emphasizes the outputs or results of the IP, results subcomponent 190 modifies the AI prompts using adjust prompts 160 to capture those results effectively in the disclosure.

Disclosure processor 150 processes the data and adapted prompts and generates an AI-based IP disclosure 140. This comprehensive description may include enabling content, procedures, and functionalities relevant to the IP, such as an invention.

Based on the type of IP and description provided, drawing type determination component 170 determines the appropriate types of technical drawings needed, such as flow diagrams for processes or mechanical drawings for devices.

Drawing generator 130 utilizes prompts from drawing type determination component 170 to create the necessary technical drawings that visually represent the IP. These drawings are then incorporated into the IP disclosure 140.

IP Disclosure 140 (e.g., invention disclosure) is the final output produced by the IPDS system, which combines the written disclosure 120 generated by disclosure processor 150 and the technical drawings produced by drawing generator 130.

In some configurations, IPDS 100 also includes reference numbers for the figures to ensure clarity and to aid in understanding—the inclusion of such details aids in enhancing the description and potential understanding of the technology such as invention for patent application purposes.

### I.2. System Description—FIG. 200

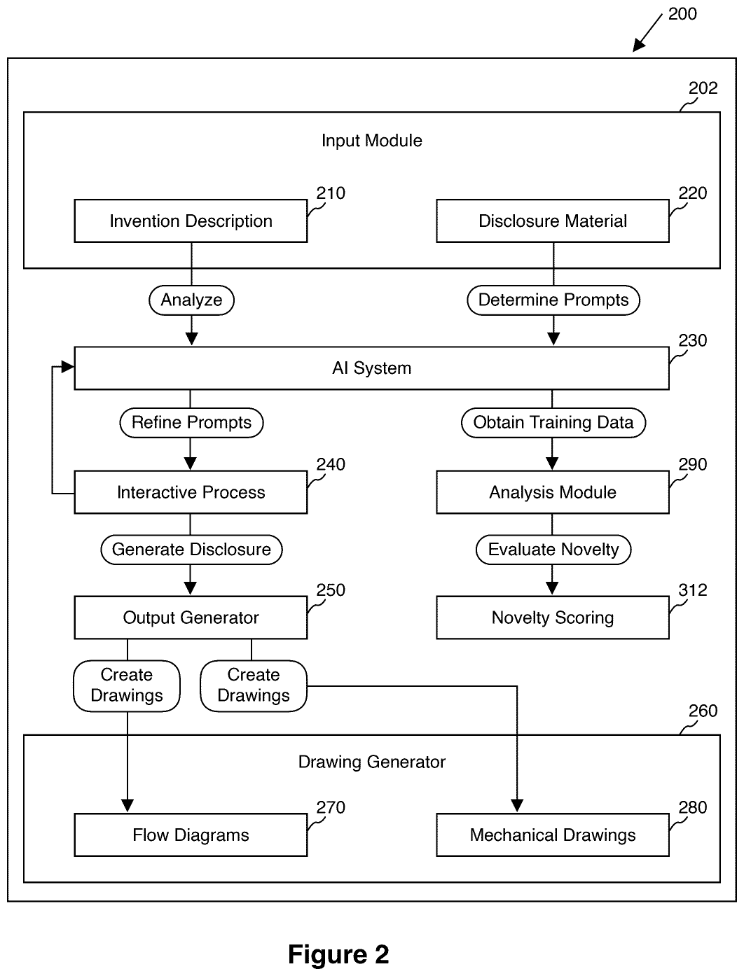

FIG. 2 illustrates an operational configuration of IPDS 100, as a system 200 designed to facilitate the creation of IP disclosures such as technical papers, patent applications, and the like, using automated systems such as artificial intelligence (AI).

The following provides a sample step-by-step breakdown of how each component functions within the system 200 regarding IP such as invention disclosures 140:

Input Module 202 is the entry point of system 200 where the user provides information about their IP such as new technical innovations.

Invention description module 210 receives a narrative description of the IP, which could vary in length and detail.

Disclosure material data 220 encompasses various forms of material that convey information about the IP, such as written documents, spoken descriptions, images, artwork, hand sketches, audio files, video, and the like.

AI System 230 provides one or more AI systems, such as an AI LLM, which process the received input from input module 202.

AI system 230 analyzes invention description data input via invention description module 210 and uses the disclosure material 220 and inputted prompts that will guide the automated system such as AI system 230 in generating the IP disclosure.

System 200 accesses analysis module 290 to obtain training data that is relevant to the IP's domain. This helps ensure that the prompts are tailored accurately to the context of the innovation and/or technology.

Interactive process 240 works in conjunction with the AI System 230 to refine prompts through an interactive loop to ensure they align closely with the information related to the IP. The refinement continues until the prompts fall within a threshold or specific range that represents the IP accurately enough to satisfy enablement standards such as found in patent law.

Once the prompts are refined, output generator 250 generates disclosure for the IP based on interactive process 240.

Drawing Generator 260 is a subsystem designated for creating visual representations of the IP, which includes:

Flow diagrams 270 generates flow diagrams if the IP involves a process.

For IP with mechanical components, mechanical drawings component 280 generates the appropriate mechanical drawings.

These drawings are part of the output and are annotated with reference numbers as typically required in patent applications, papers, technical writings, and the like.

Analysis module 290 further analyzes the generated content and oversees the training of the AI, ensuring that it is informed by a dataset comprised of relevant prior art.

Analysis Module 290 evaluates the novelty of the IP by comparing it to the body of prior art and patent claims it has been trained on. It then provides a score that indicates the likely novelty of the IP to novelty scoring component 312.

Overall, the IPDS combines input from the user with intelligent AI processing and an interactive refinement process. It produces comprehensive IP disclosures and other documents, such as patent application documents, including detailed drawings and evaluation of the IP's novelty. The system significantly enhances the efficiency of disclosure writing, including those disclosures used for patent application preparation and increases the potential quality of the documentation provided to educational institutions, professional groups such as the IEEE, patent offices, and the like.

In operation, to help secure IP protection, this AI-driven system takes a user's input description and utilizes intelligent prompts adapted to the content and detail provided, creating both a written description and the relevant technical drawings for an invention disclosure. These components work together to produce IP documentation such as a patent application-ready disclosure, adapting to focus on either detailed operational aspects or output results, depending on what has been emphasized by a user and/or other system. This leads to a detailed and comprehensive IP disclosure for use in technical papers, patent application package, and the like thereby supporting users in securing intellectual property protection.

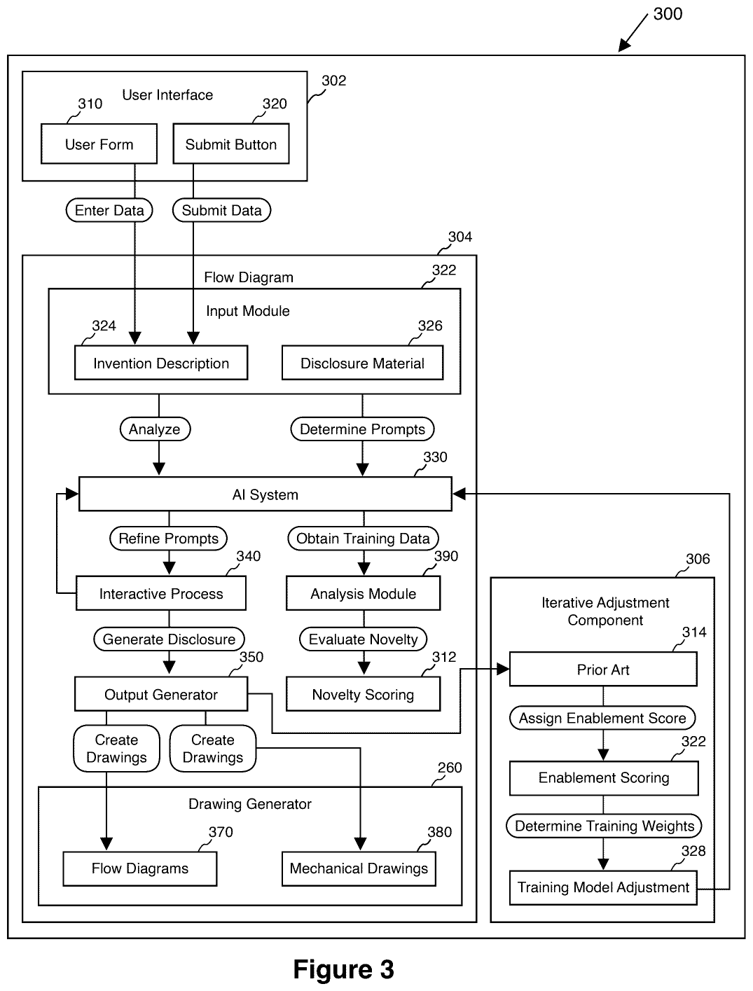

### I.3. System Description—FIG. 3

In a configuration, as shown in FIG. 3, IPDS 100, is configured as a system 300 which contains user interface 302, flow diagram 304, and iterative adjustment 306.

User interface 302 illustrates a user interface module for generating IP disclosures and/or patent applications, technical writings, and the like using an automated system such as artificial intelligence.

Flow diagram 304 illustrates an input module for generating IP disclosures and/or patent applications, technical writings, and the like using an automated system such as artificial intelligence.

Iterative adjustment component 306 illustrates an iterative adjustment process for generating IP disclosures and/or patent applications, technical writings, and the like using an automated system such as artificial intelligence.

User Interface 302 is designed for users to input specific details about their IP. Within the user interface 302 is a user form 310 where the user enters data related to their IP (e.g., invention), which may include written descriptions, spoken words, images, drawings, or other forms of material that can convey how the invention is made and used.

After entering the details, the user can submit the data through the submit button 320, which then conveys the information to the input module 322.

The input module 322 may contain two components: the invention description 324 and the disclosure material 326 modules. The invention description module 324 receives detailed information about the invention directly from the user, while the disclosure material module 326 may encompass supplemental materials provided by the user or others, such as images or sketches that help describe the IP.

As illustrated in FIG. 3, upon receiving this information and the prompts generated by user interface 302, AI system 330 processes the IP disclosure.

The prompts generated by user interface 302 may be based on the type of disclosure material 326 provided. The input module 304 adjusts prompts to ensure that the AI system 330 can tailor the processing depending on the nature and depth of the information submitted by the user.

In a configuration, AI system 330 working in concert with the interactive process 340 refines the prompts iteratively, thereby improving the AI's model to more accurately reflect the innovation. AI system 330 works either serially or parallel with analysis module 390 to obtain training data, which includes relevant prior art that is used to train the AI model, aiding in the refinement of the AI's understanding and capability to generate an accurate IP disclosure.

Applications of system 300 may be twofold through output generator 350. Firstly, output generator 350 may be configured to generate an output IP disclosure that encompasses some or all necessary details for a technical paper, patent application, etc. Secondly, output generator 350 may be configured to produce various types of drawings which include flow diagrams 370 for process-based IP and mechanical drawings 380 for IP disclosure with mechanical components. Both these diagrams may include reference numbers, as typically required in papers and other documents such as patent applications.

An additional feature of the analysis module 390 is novelty scoring component 312. Novelty scoring component 312 evaluates how novel the IP is by comparing it to known prior art. Based on how much training data is used and the outcomes of interactive process 340, novelty scoring component 312 may provide a novelty score that indicates the potential uniqueness of the invention. For example, if analysis module 390 reports to novelty scoring component 312 that a small amount of prior art was found to be able to provide an output, novelty scoring component 312 may adjust the novelty score higher to reflect that there was little prior art data. Conversely, if the analysis module 390 reports to novelty scoring component 312 that a large amount of prior art was found to be able to provide an output, novelty scoring component 312 may adjust the novelty score to reflect that there was an abundance of prior art data, suggesting that the novelty of the innovation may be low relative to the prior art.

Novelty scoring component 312 may also use the AI training data to determine the novelty of the invention. For example, since AI System 330 relies on training data (prior art), AI system 330 may provide a signal to novelty scoring component 312 indicating the level of training data found to generate an output. Here, for example, a signal indicating lower amount of training data found to use by AI System 330 may result in increasing the novelty score, indicating a scarcity of training data (prior art). Conversely, a signal reflecting a higher amount of training data found to use by AI System 330 may result in lowering the novelty score, indicating more abundance of training data.

Iterative adjustment process 306 is used to tailor the performance of system 200 by providing training data to the AI system 230. Here, prior art component 314 performs and analysis on outputted IP disclosures to determine their relevance and value. In response to input from prior art component 314, enablement scoring 322 is then applied to this prior art to assess how effectively it explains how to make and use the technology it describes. For example, if the content was a few words covering the heating of a wire filament, the prompts to the AI system may be adjusted to expand on how wire filaments are heated to a level understandable by one skilled in the art of heating wire filaments to heat filaments. In some aspects, an adjust prompts process such as adjust prompts 160 discussed herein, may compare the output of the AI system 330 to prior art used by engineers and other to determine the level of adjustment necessary.

Based on these enablement scores, a training model adjustment 328 is conducted, which adjusts the weight of how much each piece of prior art influences the AI system 330. This allows the model to become more finely tuned to the specific innovation, ensuring accurate enablement for the development of cogent IP, patenting, and other process requiring a higher level of enablement.

### Verbosity Adjustment

In some configurations, since AI systems may include extraneous information, or information that is unnecessary to enable the IP, IPDS 100 may include a verbose module used to reduce or increase the verbosity of an AI output. The verbose module may set a threshold relative to the audience the IP output disclosure is intended to be disclosed to, from beginners to experts. For example, if the IP output is about computer software, the level of verbosity may be set to decrease the explanation of how computers operate to a target audience of computer software engineers, as the target audience is skilled in computer software and its development. Conversely. if the IP output is about computer software, the level of verbosity may be set to increase the explanation of how computers operate to a target audience of the general public, as a large percentage of the target public audience may not be skilled in computer software and its development. In configurations, the enablement threshold and the verbosity level may be set as a window such that the IP disclosure is written to be enabling without being under enabled or unnecessarily verbose for the targeted audience.

In conclusion, the entire system operates in a seamless manner to convert a user's IP description into a comprehensive patent application. This is achieved through a complex but well-orchestrated series of analyses, iterative adjustments, and output generation—all steered by an underlying IPDS that adapts to the inputs it receives and refining the data sent to the AI system to create high-quality IP disclosures and drawings.

### II. Data Masking

In some configurations, a data masking process may be employed by IPDS 100 or operate separately. The data masking process may be used to prevent the public release of data when using an AI system such as IPDS 100. The data masking process may be used to hide data and/or data patterns that otherwise may expose confidential information such as trade secrets, personal information, inventions, etc. to the public, unauthorized third party, etc.

### Masking

AI systems cannot discern meaning but are trained and designed to predict the next logical symbol, word, etc. to use. In one configuration, to leverage the data pattern recognition of the AI system while preserving confidential information, and/or information that the user wants to hide or camouflage from the AI system, the masking process removes, replaces, and or alters at least some of the text, symbols, etc. entered by the user with text and/or other symbols that allow the AI system to find data patterns to provide a meaningful, high quality, and accurate output while preserving the confidential information. For example, the AI output using provide from inputting a user-entered data set that has been masked may resemble the confidential data, process, etc., so that a person, third party, or other type of data reading system reading the AI output data may still understand the output, but since at least some of the data is masked, camouflaged, or cloaked in one or more ways to obscure, hide, cloak, or otherwise alter the underlying meanings of the data, process, etc., the person or machine reading the AI output would be unable to discern the real confidential information and/or its meaning that has been hidden, altered, etc., until it is reconstructed, for example, by a reconstruction process.

In some implementations, a system such as IPDS 100 may produce a substantially similar output within a similarity threshold whether processing the original information or the masked information as the input data. In other words, a disclosure document, patent application, publication, or similar output generated by AI system such as IPDS 100 using unmasked input data would be substantially identical to the output generated by IPDS 100 when processing the same input data that has been masked.

In an implementation, the output from the AI system using the original user-entered data may be compared to an output from the AI system using the masked input data to determine whether the two different outputs fall within a similarity threshold. If the output from the AI system using the original user-entered data and output from the AI system using the masked input data are within the similarity threshold, unmasking may proceed. If not, the masking process and/or prompts for the AI system processing may be adjusted until the output from the AI system using the original user-entered data and output from the AI system using the masked input data are within the similarity threshold.

In some configurations as described herein, the masking system or other system may be used to provide an unmasking process to extract and/or reconstruct the confidential information obtained from the user to produce the original confidential information.

### Data Analysis

User entered data may be analyzed to determine locations to modify the user data being submitted by the user to the IPDS 100. For example, the masking system may be configured to determine where to place masking text, characters, symbols, etc., replace and/or add masking data to the entered data, where to modify user data, etc. The masking data may be any text, symbol, character, etc., that would obscure, alter, etc. the meaning of a phrase, word, symbol etc.

In one configuration, the masking system may be configured to add and/or subtract data to some textual data, insert additional data at specified location(s) of sentence, remove and replace key words identified by the user, mix in additional data that would obscure the meaning of the text, etc.

For example, consider the case where a user entered the description for the process of forming a wire filament that involves the step of heating and cooling the wire over three different temperature ranges that are a trade secret. In this example, the user text to input to the IPDS 100 reads:

“Given a first, second and third heating temperature used to anneal the wire, heat the wire by a first temperature over a first heating time period of between five and nine minutes, cool the wire for five minutes, heat the wire to the second temperature over a second heating time period of between ten and fifteen minutes, cool the wire for seven minutes, heat the wire to third temperature over a third heating time period of fourteen minutes, then cool the wire to ambient temperature.”

The masking system may obscure the trade secret time ranges by inserting different numbers, adding extra steps, etc. Here, for example, the masking system may be configured to obscure the data by replacing the trade secret time ranges with different ranges. The masked text may read as follows:

“Given a first, second and third heating temperature used to anneal the wire, heat the wire by a first temperature over a first heating time period of between fifty-five and seventy-seven minutes, cool the wire for two minutes, heat the wire to a second temperature over a second heating time period between thirty and forty minutes, cool the wire for seventeen minutes, heat the wire to third temperature over a third heating time period of forty seven minutes, then cool the wire to ambient temperature.”

The IPDS 100 would use the masked input data and provide an output based on the masked data. For example, in this scenario the IPDS 100 would describe a wire filament formation process based on the masked description and provide an output thereof to the user. The masking data therefore has hidden trade secrets (the actual heating time periods) from third parties who have access to the AI data.

To avoid AI systems, third parties, and others from trying to determine and remove the masking information, the masking system may use a randomizer to randomly pick masking data, symbols, and images, etc., that while obscures the confidential aspects of the user data, the masking data is still viable for use by the AI system to perform its pattern analysis to thereby provide a meaningful output. For example, based on the above scenario, if the subject of the user confidential data is heating an alloy wire that changes properties after the confidential heating process, the randomizer may input heating a standard aluminum and nickel alloy wire specification that would still allow the AI system to provide a cogent output for annealing the user's alloy wire. A third party trying to learn about the user's process and wire would not see more than a process for annealing aluminum and nickel alloy wire.

In some configurations, the masking system may be adjusted to allow the AI system to provide more or less relevant output. For example, the masking data may be altered to allow an increase or decrease in “hallucinations” by IPDS 100 to increase or decrease the amount the confidential process, etc. is obscured. In a scenario, the masking system may be used to compare different outputs to determine a level of acceptable “hallucinations,” which may be used to obscure the confidential data. For example, more “hallucinations,” may lead to an output that obscures the confidential information more, whereas less “hallucinations,” may result in an output where the confidential data is obscured less by the “hallucinations.” In summary, the “hallucinations” may be configured and used as additional masking data generated by IPDS 100.

In other configurations, the masking system may be used to break apart the user input into meaningful sections of chunks that may be used to both provide a viable input to IPDS 100 while separating the AI processing into different processing threads. The output of the IPDS 100 from the processing threads may then be reassembled by the masking system or another system such as AI system used for processing confidential information. For example, using the above wire filament example, the masking system ascertains meaningful data that IPDS 100 could then use, and breaks the user data into a plurality of that meaningful data. Here the meaningful data could be pulling out the topic of “wire filament” which IPDS 100 can use to create an output based on training data about wire filaments. The masking system could then individually break out the first, second, and third heating ranges and process them separately such that IPDS 100 could describe a first heating process as one output, a second heating process as a second output, and the third heating process as a third output. Since the processing threads may not be consecutive, or even done by the same AI thread, a third party would find it impossible to piece the confidential processes together.

### Reconstruction—Removing the Masking Data

IPDS 100 and/or a third-party system may be configured to keep track of the masking information so that it may be removed after IPDS 100 process the confidential data along with the masking data to provide the output to the user. Here, the masking system could then be used to reconstruct the processes, for example, by replacing the masked data in the output with the unmasked data. In addition, proprietary assembly tags may be used in the input that allow the masking system to help in reassembling the correct output.

For example, based on the above scenario, a third-party system may create a table of actual and masked data so that the masked data in the output could be replaced by the actual confidential data, e.g., the third-party system keeps track of the trade secret heating time periods and replaces the masking heating time periods (e.g., fifty-five and seventy-seven minutes) with the matching trade secret time periods (e.g., five and nine minutes) in the disclosure output from IPDS 100.

### III. User Interface

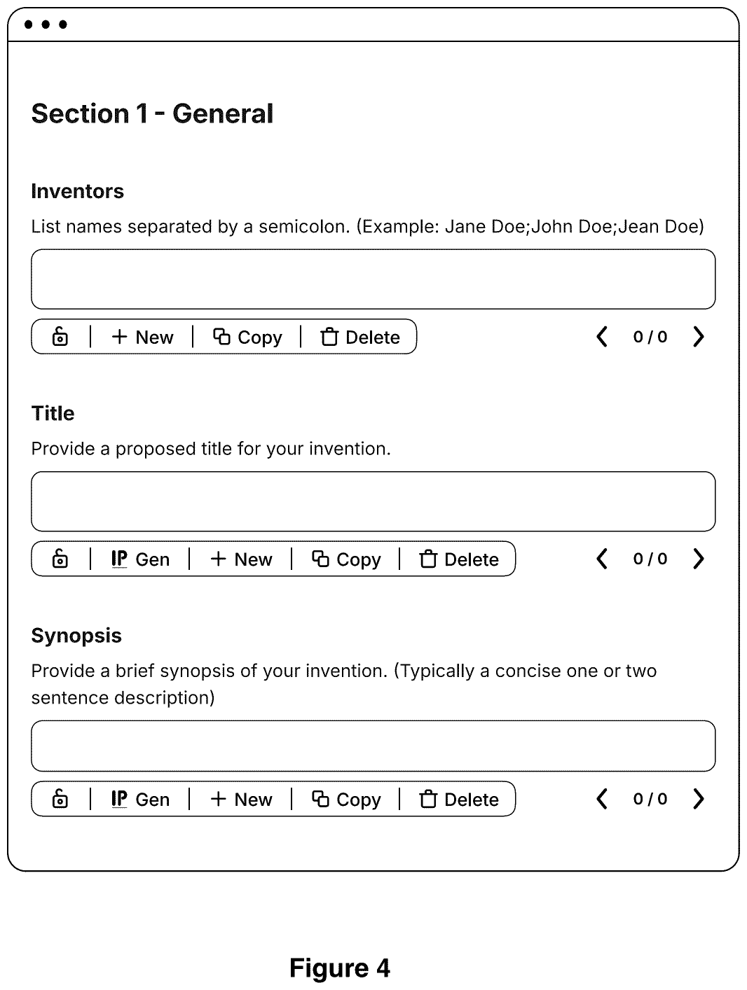

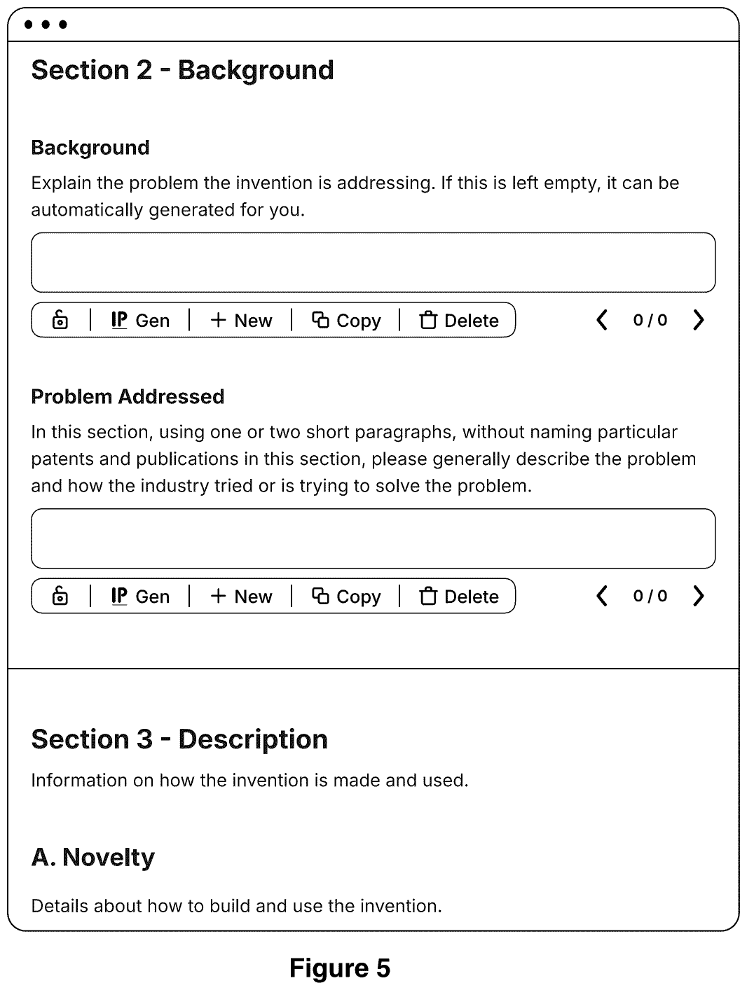

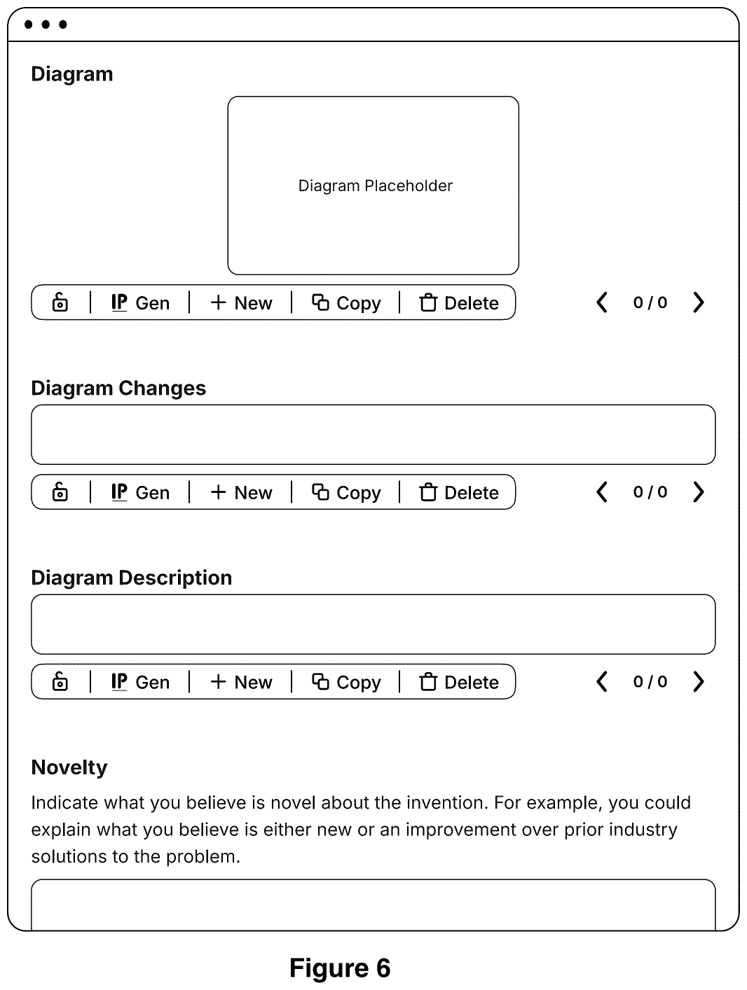

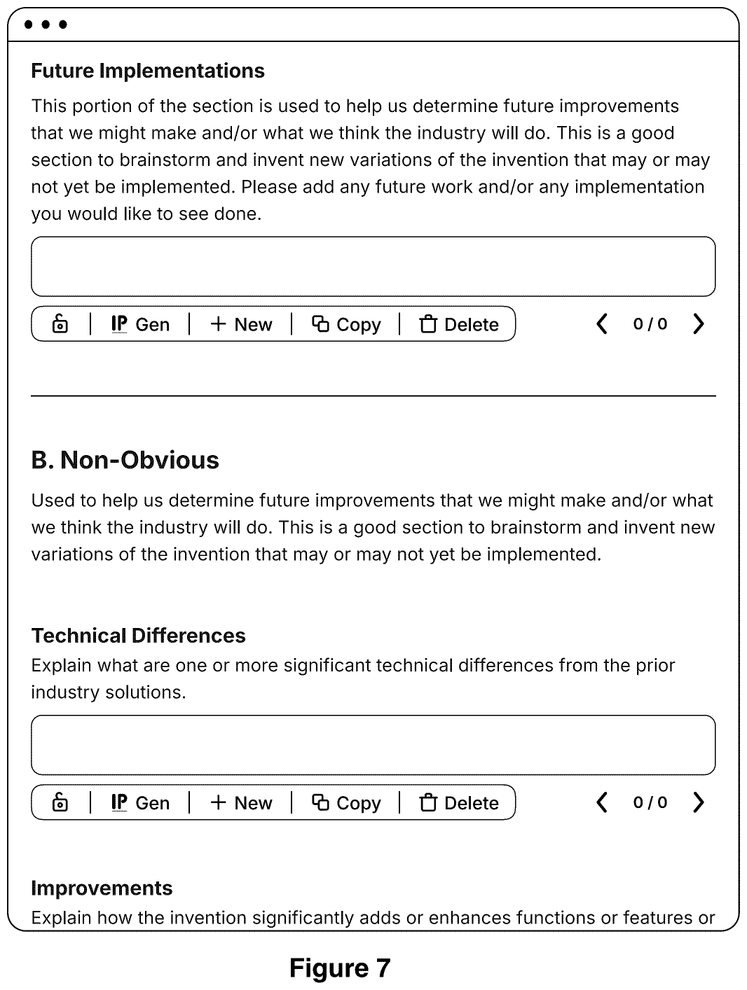

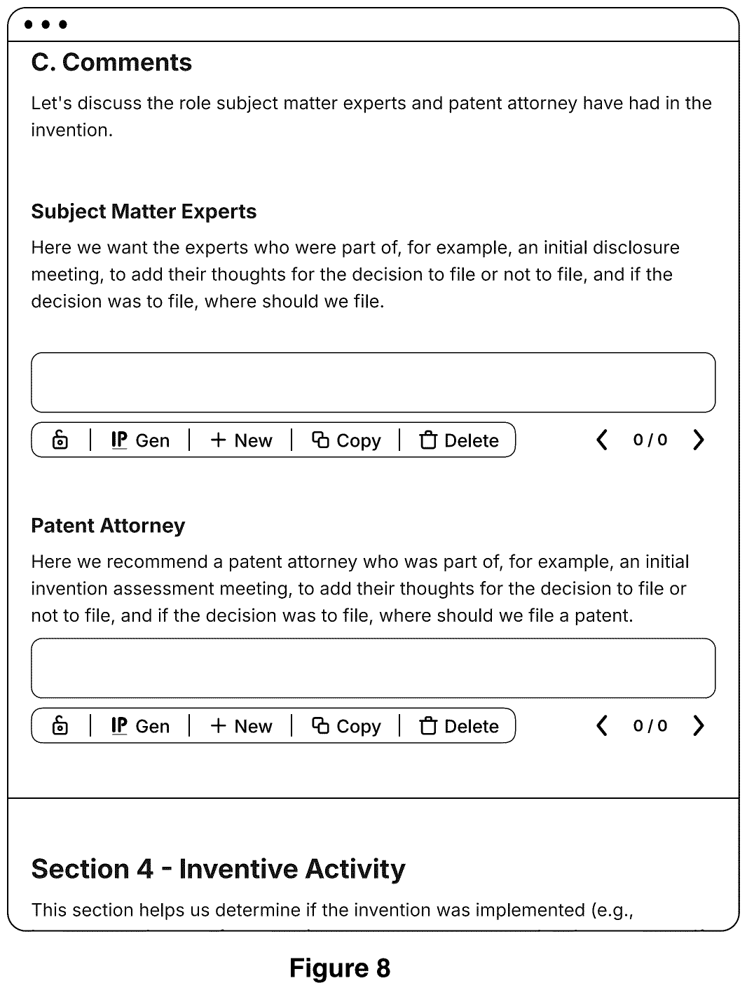

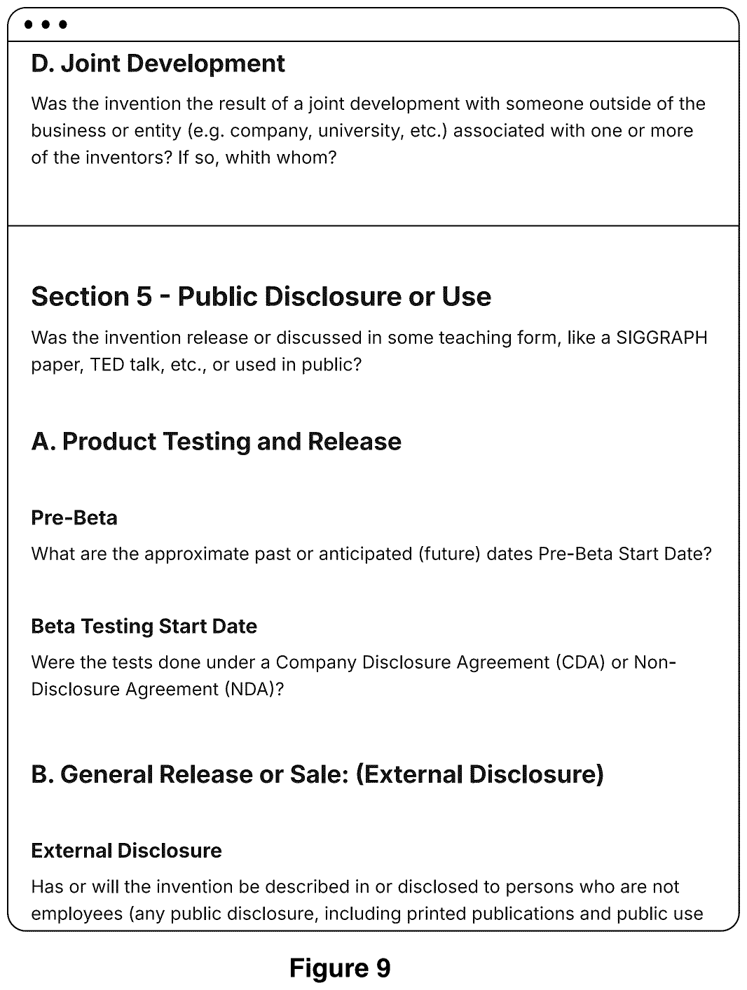

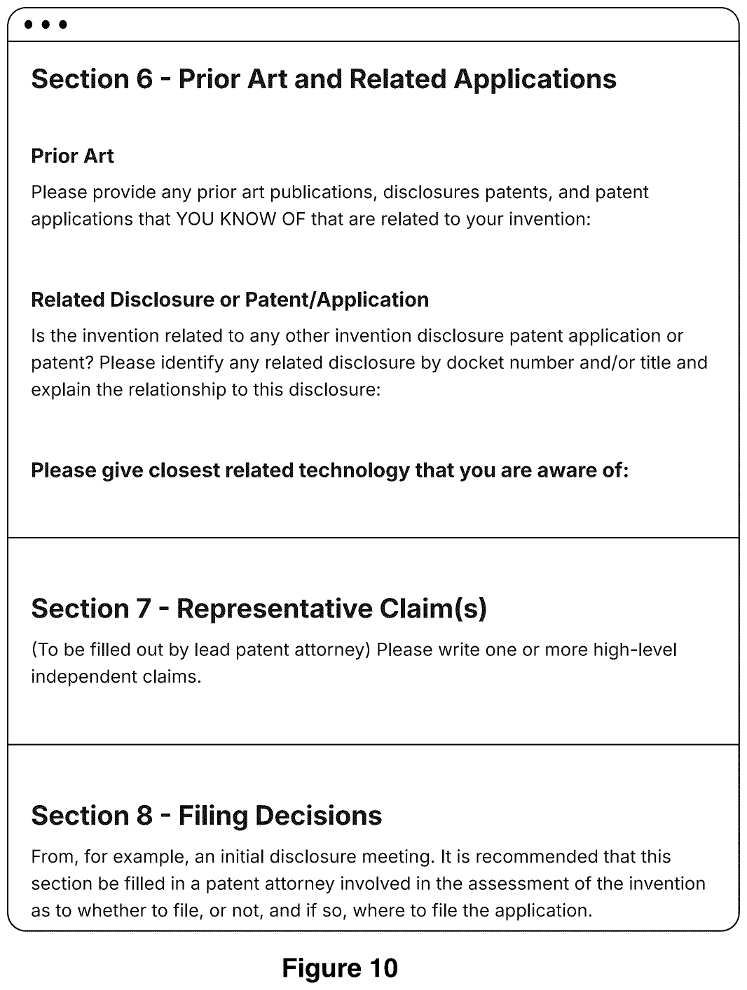

FIGS. 4-10 include screenshots of an example user interface for an “invention disclosure form,” or “intake” form that has been automated. Although the example intake form is used to describe various embodiments of the invention, it should be apparent that many variations of the intake form are possible and the specifics of this intake form are just an example. Further, features of the embodiments may be applicable to other types of forms such as a system for creating provisional patent applications or utility patent applications; copyright or trademark applications, or other types of intellectual property-related, or other legal forms.

FIGS. 4-10 show the blank form as it is first presented to a human inventor, or user. Sections of the form are accessed by scrolling and panning within a window, such as a window on a browser page, in a known manner. Text input boxes are placed at various points in the form to allow a user, or computer, to input text. For example, FIG. 4 shows input boxes for “Inventors”, “Title” and “Synopsis”. The example form illustrated in FIGS. 4-10 omits input boxes for some sections for ease of illustration. The example form includes several sections that need not be included in other, more simplified, intake form designs. Other forms can vary widely from the present example.

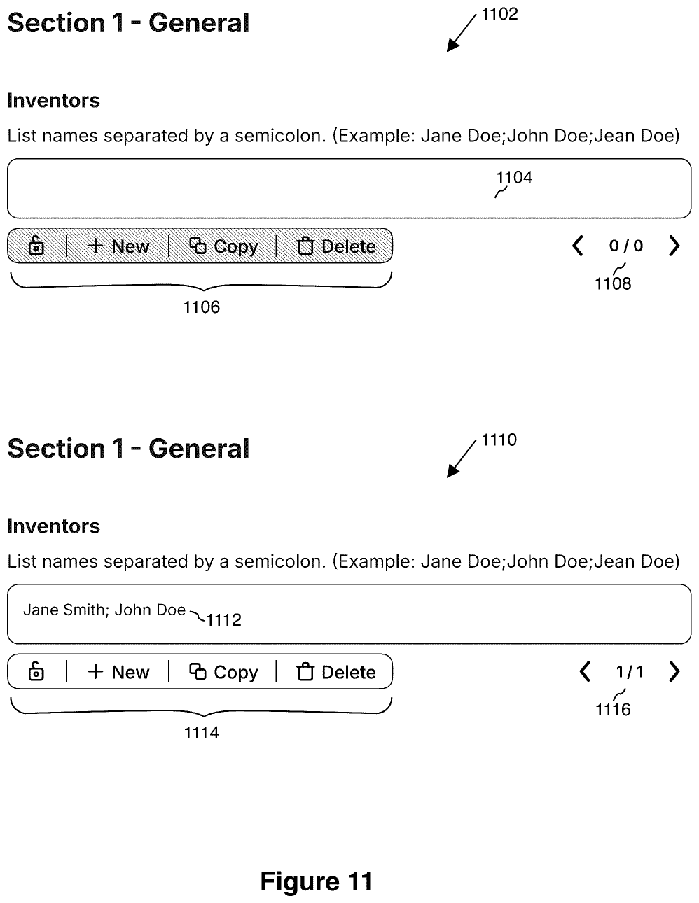

FIGS. 11-13 illustrate steps in a user inputting information into an input box, and also automatically generating text for an input box.

In FIG. 11, screenshot 1102 shows the Inventor Names input box 1104 which is blank as the user has not entered any text. Edit buttons 1106 are shown greyed-out as they are not active since no text is present in the input box. Block indicator 1108 shows that the display is block zero of zero total since no text has been entered yet.

Next, in FIG. 11, screenshot 1110 shows the same Inventor Names section where the user has typed a couple of inventor names at 1112. Since text has now been entered, edit buttons at 1114 have become active. These buttons are “Lock/Unlock”, “New”, “Copy” and “Delete”. Block Indicator 1116 now shows that the text block being displayed inside the input box is block 1 of a total of 1 blocks.

Using the edit buttons at 1114, the user can Lock the text block from further modifications. The user can create a new, empty text block; copy the present text block to a new text block; or delete the present text block. As the user, or a computer, creates new text blocks, the total number of blocks available for the section increases and block indicator 1116 updates.

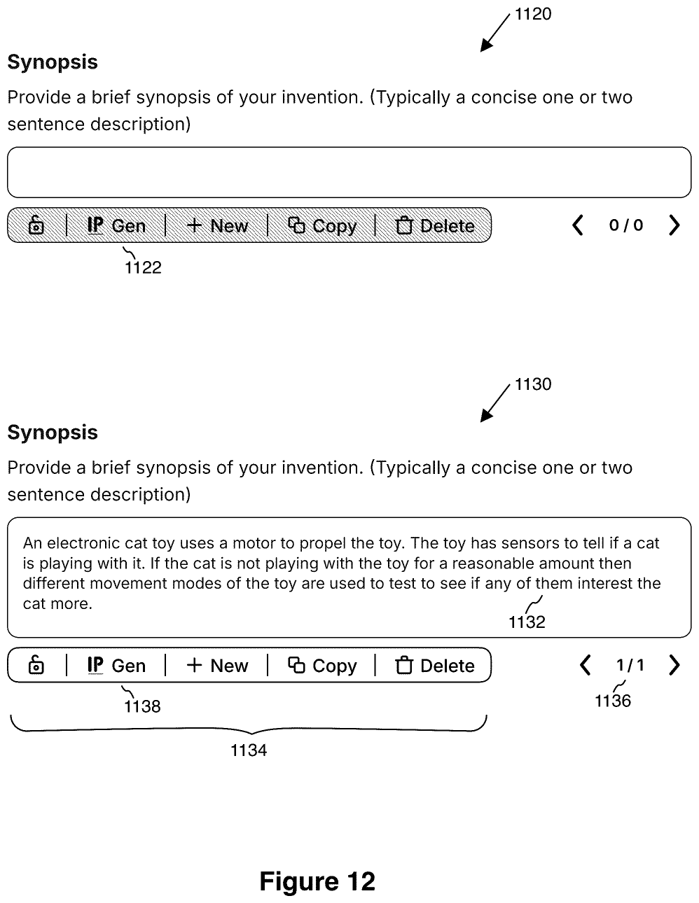

FIG. 12 shows Synopsis section screenshot 1120. At this point, no text has been entered and all the control buttons are greyed-out (i.e., not operable). This input text box is provided with a Gen button 1122 that will become operable once text has been input.

Screenshot 1130 shows the Synopsis section input text box after the user has typed text 1132 into the input box. Buttons 1134 are now operable, including Gen button 1138. The block indicator shows the displayed text block is block 1 of 1 blocks, total.

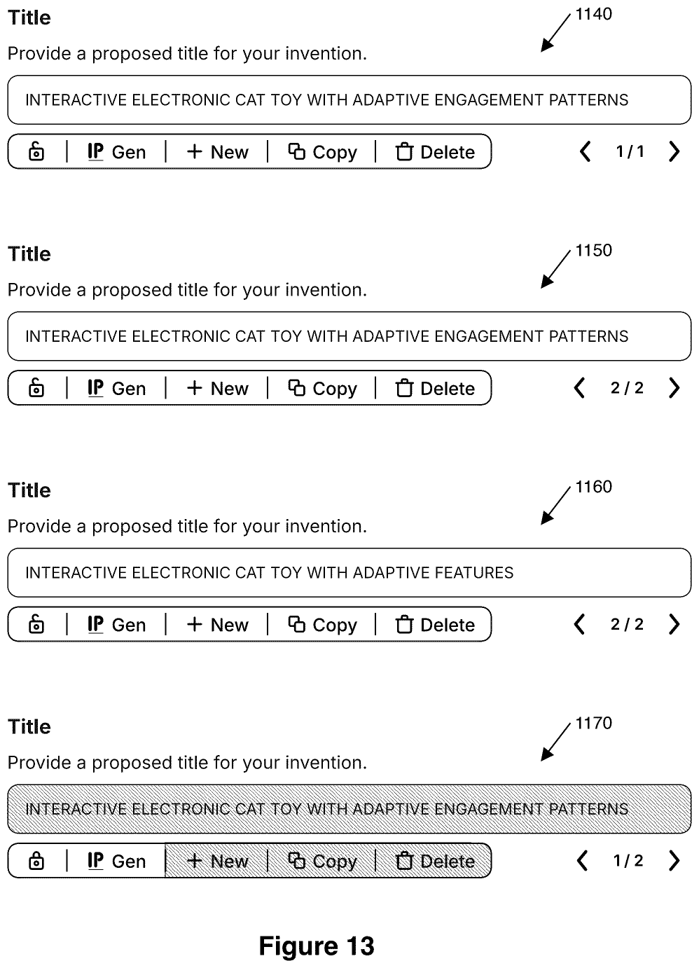

FIG. 13 shows the result the user pressing Gen button 1138 of FIG. 11. Screenshot 1140 shows the Title section that has been filled automatically with AI-generated text based on the Synopsis text that was input by the user. Screenshot 1150 shows the display after the user has pressed the Copy button in 1140. Note that the text block has been copied to a new block and the block indicator shows “2/2”, which means the second of a total of two text blocks for this input box is being displayed. The left and right angle brackets allow the user to navigate to the previous or next, respectively, blocks in the sequence. Only the left angle bracket is active as the only option at this point is to move back to an earlier block as the display is showing the last block in the block sequence.

In FIG. 13, 1160 shows that the user has edited the text for the Title to shorten it. At 1170, the user has moved back to the original Block 1 by pressing the left angle bracket and the block indicator now shows “1/2”. Also, the user has pressed the LOCK button to lock the current block from any further changes, unless the Lock button is pressed again to unlock this input text box.

Similarly, in this manner, various input text boxes in the Intake Form can be supplied with text by the user, or be automatically filled with text by a computer, such as by using an AI LLM system, such as IPDS 100, or other approach. For example, in a particular embodiment, a user is required to input Synopsis text and then pressing the Gen button automatically generates text for the Title, Background and Overview sections. Each time a text block is automatically generated it is added to the block sequence so that no prior text is lost. The user can then work within any of the sections to edit the text blocks, or to generate new blocks by pressing the Gen button below a particular input box. Once the desired text for an input box is achieved, the user Locks that text from further changes. In a particular embodiment, a locked text block prevents displaying other blocks within the input text box and prevents any modifications to the locked text block. It still allows new blocks to be generated automatically and the new blocks are added to the end of the block sequence for that input box while still maintaining the locked text block as the displayed block.

In a particular embodiment, any one or more text blocks (or diagram descriptions, images, audio, video or other types of data) can be used as inputs to an automated system (e.g., an AI system such as an LLM). An optional prompt can be provided as additional instructions to the LLM along with the inputs, or in place of any inputs. Any one or more blocks can be received as outputs from the automated system and added as new blocks to block sequences associated with text boxes.

For example, the Title input box can be generated by pressing its Gen button. This causes the currently displayed Synopsis and Overview blocks of text to be used along with a prompt to an LLM system to generate a new title. Typically, a Gen button associated with an input box will be designed to re-generate text for that single input box. In some cases the re-generation of text may only use the text present inside an input box, if any, along with a prompt supplied by the intake form system, to invoke the LLM for new text for that input box. In other cases, a Gen button associated with an input box may be used to generate text for other boxes in addition to, or in place of, generating text for the associated input box. For example, in an embodiment, pressing the Gen button on the Synopsis input box causes the Title, Background and Overview input boxes to be populated with new text. Many variations are possible.

### IV. Measuring and Managing Inventor Participation

Embodiments allow the intake form system IPDS 100 to measure and/or manage human inventor participation. User-created text, or other input content, can be measured and compared to the amount of machine-created content. For example, where text is concerned, a character, word, sentence, or other count (e.g., “tokens” in the case of LLM outputs) can be used to measure the user input as a percentage of total contents. In the case of other media such as images, audio, video, etc., a file size, pixel or frame count, or other metrics can be used.

The user ParticipationDegree can be shown in real-time on the screen so that the user, manager, or other interested parties can judge whether the user's participation meets goals or requirements. The ParticipationDegree can be associated with the intake form and kept along with the form's other data.

The ParticipationDegree can be tracked per intake form, intake form section, paragraph or by other granular divisions. Different parts of the intake form can be given different weights. This allows, for example, more invention-related sections such as the Synopsis and Future Implementations sections to have higher weight than sections such as Background or Problem Addressed. As described herein, high-value phrases, words or values can be given higher weight than other types of words such as adjectives, articles, particles, etc. which may be weighted at little, or no, value with respect to a ParticipationDegree.

In an embodiment, a company can require that inventor participation for the form, or for certain sections or other parts of an input document, be at least a predetermined threshold level. The current level can be provided on the form as the inventor works with the form-generating text manually or automatically-so that the inventor can know whether they have met a threshold requirement. Such a requirement can be adjusted automatically as, for example, where a patent office rule, guideline or patent-related law is implemented or changes.

An inventor can be queried or forced to provide key information in order to proceed. Such key information can include the base concepts forming the genesis of an idea to be protected. For example, the Synopsis and Future Embodiments sections of an invention submission (i.e., idea intake) form may be required to be entered by a human “inventor” and any AI or other automated system can be prevented from filling out all or a portion of such sections.

Where measurements or values are needed such as, for example, a temperature range, dimension, distance, molecular makeup, etc., the user can be required to enter such values. A placeholder for the values needed can be output to the user along with the context (i.e., surrounding text) in which the values, names or additional information will be used. The placeholder can be a blank line, or tag such as “[ENTER TEMPERATURE RANGE]”. In an embodiment, the user will not be allowed to complete or finalize the submission form until all the required information is provided, or the need for the information has been eliminated such as by deleting the sentence, paragraph or section that requires the key information.

### V. Anchor Text

In addition to providing for locking whole text blocks, parts of text blocks such as paragraphs, sentences, or words, can be locked to prevent changes to those text parts. The text locked at a sub-block level is called anchor text, and can also apply to any portion or category of larger portions or arbitrary parts of text in any document. Anchor text can be designated by the user or by an automated system, such as an AI, AGI or procedurally programmed code.

For example, a user (or computer) can highlight text that is not to be changed, or that should be used with more emphasis in a prompt to an automated system. The intake form system detects the text and formulates a prompt to the AI to, for example “make sure to use the indicated text in your output” and/or “do not change the indicated text” and/or “expand upon the indicated text”, etc. Conversely, the user can highlight or otherwise designate text that must be changed by the automated system.

The following numbered paragraphs 1-6 list short descriptions of additional features that were generated by a prompt to an artificial intelligence LLM. The inventors' claim protectable intellectual property ownership in these descriptions (or derivations, thereof) only to the extent permitted under relevant laws and regulations, which may change over time. The descriptions of novel features, above, were developed without reference to the numbered descriptions, below.

### 1. Interactive AI-Feedback Loop

The system could offer an interactive feedback session where the AI presents drafts of the application and the inventor can provide real-time feedback. This could include questions from the AI for further clarifications, suggestions for improvement, and iterative refinement until the final draft meets the inventor's satisfaction.

### 2. Peer-Review Simulation

Incorporating a virtual peer-review feature where the system can simulate the review process that a patent application might undergo. This would enable the system to foresee possible objections or areas needing clarification and address potential issues before the actual submission of the patent application.

3. Integration with Patent Databases

The system could be integrated with national and international patent databases, enabling it to perform real-time checks against existing patents to ensure uniqueness and to provide more accurate novelty scores. Additionally, integration with legal databases would help ensure compliance with the latest patent laws and regulations in different jurisdictions.

### 4. Automated Patent Claims Generation

The AI system could be improved to suggest and draft patent claims based on the detailed description provided. These claims could be tailored to ensure that they meet legal criteria for patentability, such as novelty, non-obviousness, and specific claim structure requirements.

### 5. Confidentiality and Security Features

Implementing advanced confidentiality and security features, such as end-to-end encryption, to protect the sensitive details of the invention during the input and generation process. This would provide inventors with assurance that their proprietary concepts are secure from intellectual property theft or unintentional disclosure.

### 6. Post-Patent Application Monitoring Tool

Develop an AI-driven monitoring tool that alerts the user to new patents or publications that might be relevant to their invention after the application has been filed. This could help in keeping the patent application up to date and in making any necessary amendments or adjustments to the scope of the claims based on the emerging prior art.

Although the description has been described with respect to particular embodiments thereof, these particular embodiments are merely illustrative, and not restrictive. The automated content generation described herein is typically performed by a computer system. Such a computer system can be any presently existing system or any suitable future-developed system. Currently Large Language Model (LLM) systems are being used for text generation but other systems can be used as they are developed, such as Automatic Generative Intelligence (AGI), etc. Any approach to computing can be used including local or remote processing; local or remote models, parallel processing, etc.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for measuring human user participation in a digital system that accepts inputs to describe original intellectual property (IP), the method comprising:
measuring an amount of user-created input describing the IP;
measuring an amount of machine-created input describing the IP;
determining a user participation degree using at least a portion of the measured amounts; and
if the user participation degree does not meet a predetermined condition, then prompting the user to increase the amount of user-created input.

2. The method of claim 1, wherein measuring includes:
measuring an amount of text.

3. The method of claim 1, wherein measuring includes:
measuring an amount of tokens.

4. The method of claim 1, wherein measuring includes:
measuring an amount of image information.

5. The method of claim 1, wherein measuring includes:
measuring an amount of audio information.

6. The method of claim 1, wherein the IP includes a work of art.

7. The method of claim 1, wherein the IP includes an invention.

8. The method of claim 7, wherein the digital system includes a user interface with a displayed form for entering information.

9. The method of claim 8, wherein the form includes an invention intake form.

10. The method of claim 9, wherein the intake form incudes sections, further comprising:
weighting the measured amounts based on the section into which the an amount is entered; and
using the weighted measured amounts to determine the user participation degree.

11. The method of claim 10, further comprising:
requiring different participation degrees for different sections.

12. The method of claim 1, further comprising:
prompting the user for values.

13. The method of claim 12, further comprising:
inserting a tag into the input text as a readable requirement for the user to provide a value.

14. The method of claim 1, further comprising:
wherein if the user participation meets or exceeds the predetermined condition:
masking at least a portion of the user-created input data forming a masked set of the user-created input data to prevent public exposure of the masked set of the user-created input data; and
processing the masked set of the user-generated content with an artificial intelligence (AI) system, wherein an output from the AI system processing the masked set of the user-created input is substantially similar to the output that would have been produced by the AI system using the user-generated input data.

15. The method of claim 14, further comprising:
wherein masking includes substituting at least some of the user-created input with different set of input data forming the masked set of data.

16. The method of claim 15, further comprising:
unmasking at least some of the machine generated content to expose at least a portion of the user-created input that was masked as part of the user-created input.

17. The method of claim 14, further comprising:
wherein masking includes replacing at least some of the user-generated content with masking data configured to increase hallucinations of the AI system used to obscure at least of the IP inputted.

18. The method of claim 14, further comprising:
wherein masking includes breaking up at least some of the user-generated content into a plurality of different AI processing threads.

19. An apparatus for measuring human user participation in a digital system that accepts inputs to describe original intellectual property (IP), the appartus comprising:
a digital processing system configured to execute instructions for:
measuring an amount of user-created input describing the IP;
measuring an amount of machine-created input describing the IP;
determining a user participation degree using at least a portion of the measured amounts; and
if the user participation degree does not meet a predetermined condition, then prompting the user to increase the amount of user-created input.

20. A tangible machine-readable medium for measuring human user participation in a digital system that accepts inputs to describe original intellectual property (IP), the medium including instructions executable by a digital processor for:
measuring an amount of user-created input describing the IP;
measuring an amount of machine-created input describing the IP;
determining a user participation degree using at least a portion of the measured amounts; and
if the user participation degree does not meet a predetermined condition, then prompting the user to increase the amount of user-created input.
